(19) United States
(12) Patent Application Publication
(10) Pub. No.: US 2003/0159658 A1
(43) Pub. Date: Aug. 28, 2003

(54) Method and apparatus for discharging feed from a hopper

(76) Inventor: Danny Adams, Bowdon, GA (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/309,693

(22) Filed: Dec. 4, 2002

Related U.S. Application Data
(60) Provisional application No. 60/341,127, filed on Dec. 13, 2001.

(51) Int. Cl. A01K 1/10; A01K 5/00; A01K 39/00

(52) U.S. Cl. 119/53

(57) ABSTRACT

A method and apparatus for discharging feed from a hopper. Feed is introduced into a bin with a gate or valve positioned beneath the discharge opening in a lower portion of the bin to inhibit discharge of feed. Feed is intermittently discharged from the opening by selectively moving the gate or valve at least partially away from the opening to permit feed to flow through the opening.

### CROSS-REFERENCE TO RELATED APPLICATION

This application claims the benefit of priority of U.S. Provisional Application No. 60/341,127, filed Dec. 13, 2001.

### BACKGROUND OF THE INVENTION

1. Field of the Invention

The present invention relates generally to dispensing apparatus and, more particularly, to a gravity feed dispensing bin apparatus. Such apparatus allows bulk material that is loaded through an inlet to flow under the force of gravity to an outlet from which the material is dispensed. Generally, such bins are comprised of enclosures having an inlet at an upper end utilized to fill a cavity, an outlet at its lower end utilized to dispense the material, and the flow control device located at or near the lower opening for controlling the amount of material being dispensed. In operation, as the material is being dispensed, gravity pulls the remaining material in the cavity towards the lower end to replace the dispensed material. These types of bins generally include a downwardly-curving inner wall that forms a chute to channel the dispensed material to its point of use.

The present invention is generally related to a hopper for granular products, such as pellets, and is more particularly directed to a discharge mechanism for a hopper. More specifically, a method and apparatus for discharging the particulates or pellets in the hopper which interrupts the discharge flow of products through the use of a gate or valve positioned beneath the outlet port of the hopper.

2. Description of the Related Art

One conventional type of hopper comprises a large bin. Feed or food material is introduced into the bin near the top, and is traditionally discharged through a gate or valve located beneath the bin.

Numerous animal feed dispensing mechanisms are disclosed in the prior art such as U.S. Pat. Nos. 6,269,770, 5,850,805, 6,182,869, 5,857,425, and 5,626,095. All the prior art patents contain various discharge mechanisms all of which have drawbacks which either lessen the efficiency of the apparatus or block the discharge mechanism so as to require frequent maintenance or cleaning.

Hopper discharge mechanisms have previously been developed which release feed or food material through a port positioned at the bottom of the hopper. This is traditionally accomplished by a plate which is positioned so as to cover the discharge opening of the hopper, but which can be slid away from the opening to permit feed or food product to fall through the port. In other words, mechanisms have previously been developed which effectively form a horizontal slide gate discharge. With such discharge mechanisms, no product can flow when the plate is in the closed position, but when the plate is pulled away from the fixed openings, product can flow.

There are numerous drawbacks associated with the described discharge mechanism. One primary drawback of such discharge mechanism is that the plate is slid horizontally away from the openings to permit product to discharge. The weight of the product on the plate renders sliding the plate to discharge product very difficult since one must grasp the plate by hand and pull on a lip thereof to slide it away from the opening. When this is accomplished, the plate slides along the bottom of the hopper, around the periphery of the fixed opening which, although serving to scrape product off of the plate, causes wear on the plates. Additionally, since there is typically some product pellets or particulates remaining on the plate itself, it is virtually impossible to wipe all of the product off of the plate as it opens. Moreover, in most applications it is not necessary to entirely open the fixed opening, but rather the plate is only moved so that a portion of the fixed opening is unobstructed. As a result, product tends to accumulate on the plate in proximity to the obstructed area of the opening, thereby adversely affecting material flow and increasing the force required to slide the plate to a closed position. The plate must be grasped, usually on a lip thereof, by hand and manually slid open and closed. This requires increasing amounts of effort depending on the amount and type of feed and precise opening and closing is not possible.

Accordingly, the need exists for a discharge mechanism for a hopper utilizing a sliding gate or valve discharge mechanism which is easily operated, accurately dispenses feed product, lessens product build-up, and will allow accurate discharge of product. The present invention overcomes the foregoing drawbacks and fills these and other needs.

### SUMMARY OF THE INVENTION

It is an object of the present invention to provide a method and apparatus for accurately discharging product from the hopper.

It is a further object of the present invention to provide a method and apparatus for discharging product from a hopper by intermittently obstructing and unobstructing a fixed discharge opening of the hopper.

It is another object of the present invention to provide a discharge mechanism for a hopper having a valve or gate slideably positioned such that in one position it covers the fixed discharge opening of the hopper thereby obstructing product flow, and in one or more other positions it is at least partially open relative to the discharge opening so that product may flow through the fixed opening and thereby be discharged from the hopper.

These and other objects are achieved by a new and novel method and apparatus for discharging material from a hopper. In a hopper having a bin into which feed or food products are charged, the bin has a fixed open at the bottom thereof through which feed or food material may be discharged.

### BRIEF DESCRIPTION OF THE DRAWINGS

The objects and features of the invention noted above are explained in more detail with reference to the drawings, in which like reference numerals denote like elements, and in which:

FIG. 1 is a side view of the discharge mechanism of the present invention, shown in the closed position, attached to the bottom of a hopper;

FIG. 2 is a side view of the discharge mechanism of the present invention, shown in the open position, attached to the bottom of a hopper;

FIGS. 3 and 4 are side views of the discharge mechanism of the present invention in the closed position showing the components;

FIG. 5 is a side view of the discharge mechanism of the present invention shown in the closed position;

FIG. 6 is a side view of the discharge mechanism of the present invention shown in the open position;

FIGS. 7 and 8 are side elevational views of the present invention illustrating operation of the invention and shown in the open position;

FIG. 9 is a view showing a person operating the present invention; and

FIG. 10 is a top view of the present invention.

### DETAILED DESCRIPTION OF THE INVENTION

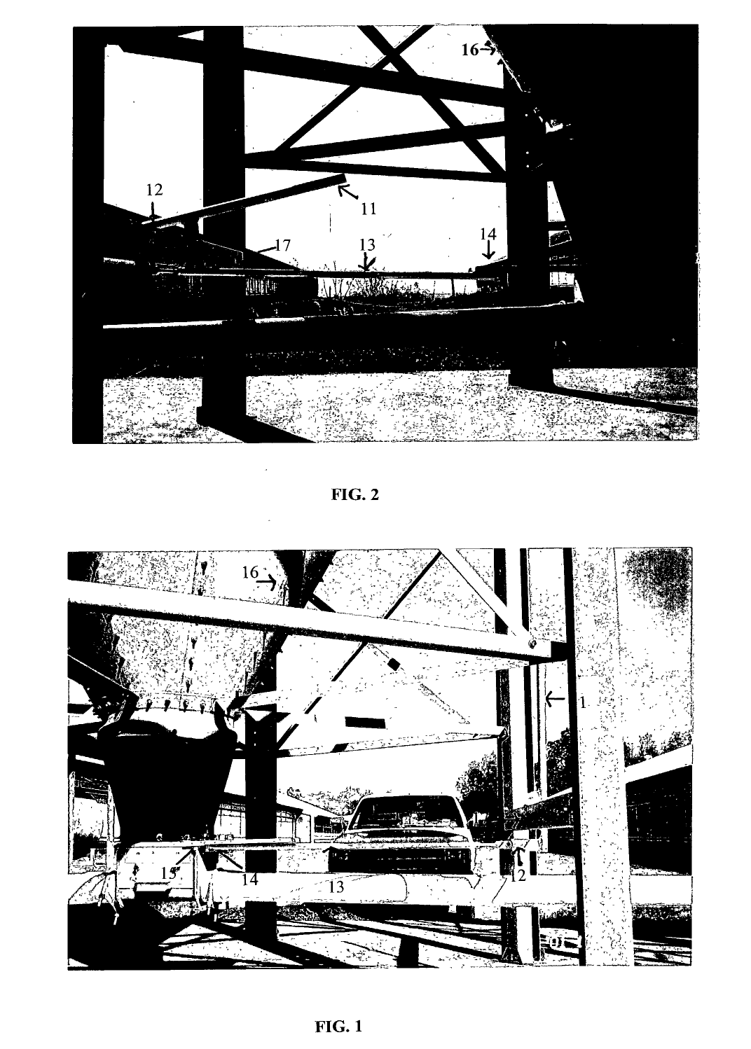

With reference initially to FIG. 1, a hopper which has an outlet in its lower portion is denoted generally by the reference numeral 16. The hopper 16 is supported by a frame, and feed or food product is introduced into the hopper 16 in its upper portion. Advantageously, as shown in FIG. 1, hopper 16 is a large bin. After feed or food product has been introduced into hopper 16, the feed or food product rests upon a sliding gate or sliding valve 15 of the discharge apparatus of the present invention. Sliding gate or sliding valve 15 has a lip 14 which in turn is attached to rod 13. Handle 11 is connected to rod 13 through pivot means 12, and is pivotally attached to a support means 17 of hopper 16.

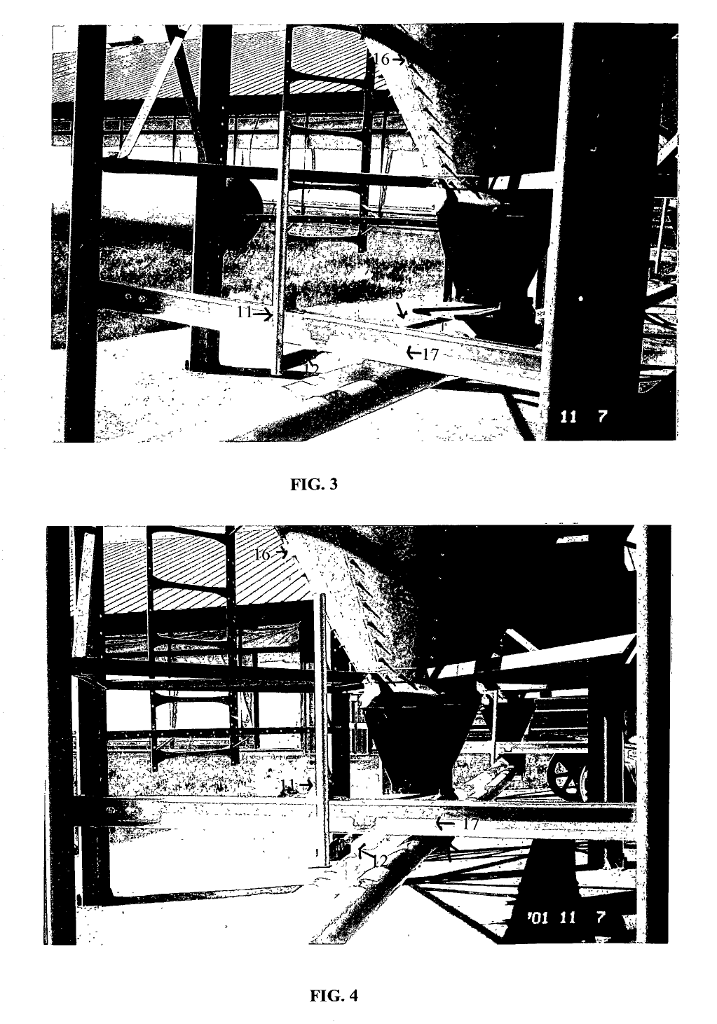

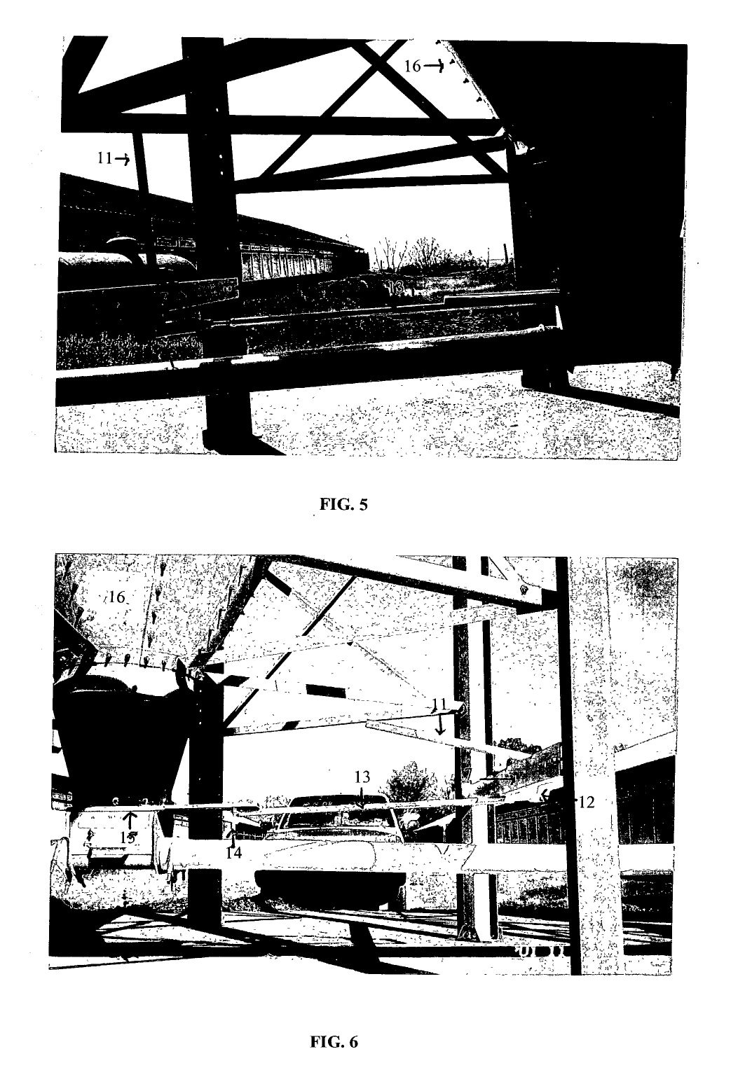

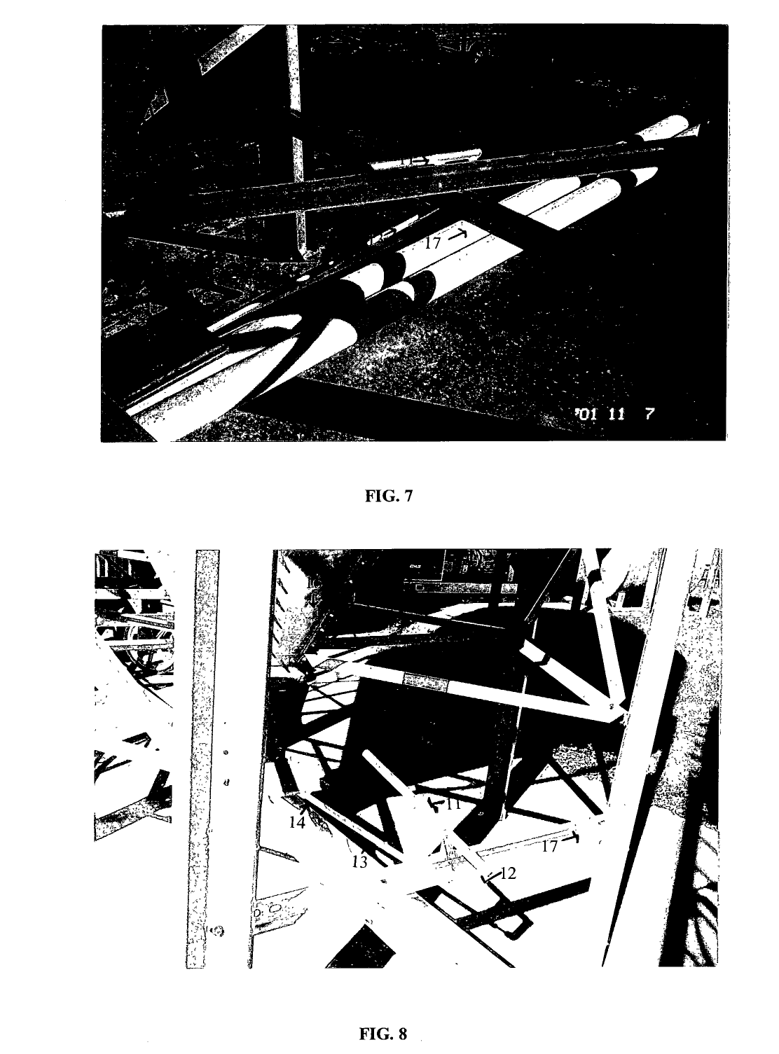

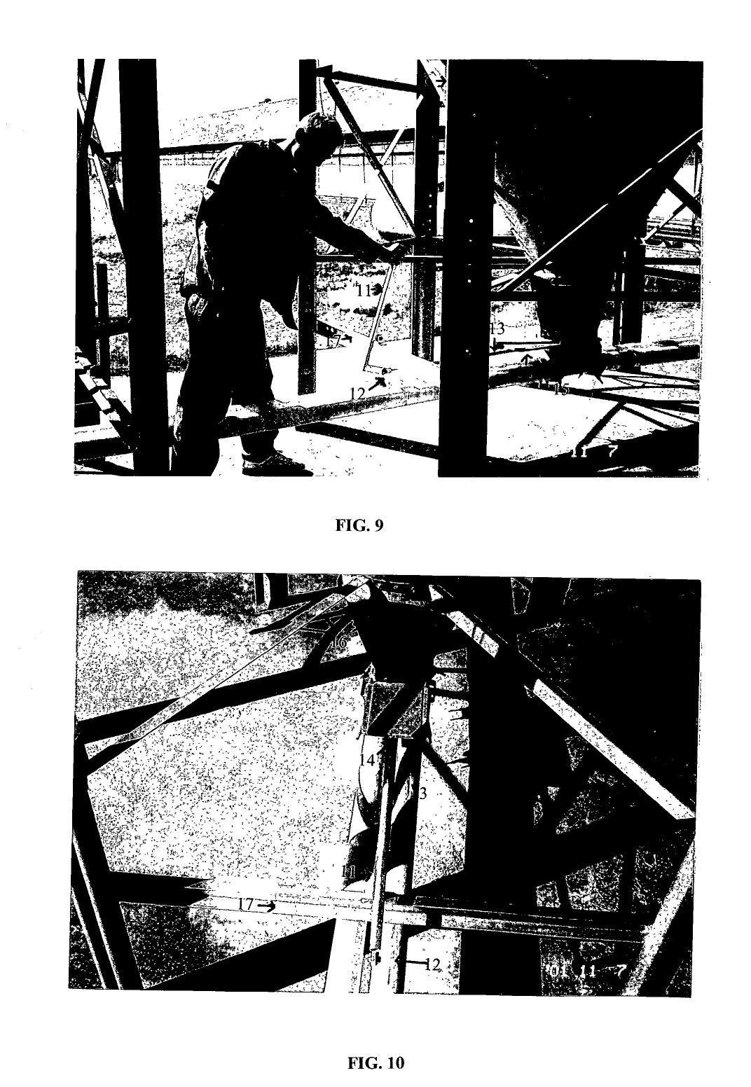

As shown in FIG. 1 (closed position) and FIG. 2 (open position), movement of handle 11 in the direction of hopper 16 imparts movement in the opposite direction to rod 13 through pivot means 12 and thereby moves sliding gate or sliding valve 15 in the direction of movement of rod 13 due to lip 14 of sliding gate or sliding valve 15 being attached to rod 13. As shown in FIG. 3, handle 11 is pivotally mounted to support means 17 of hopper 16. Movement of rod 13 in the direction away from hopper 16, because rod 13 is attached to lip 14 of sliding gate or sliding valve 15, pulls the sliding gate or sliding valve 15 open, which allows product to be discharged from hopper 16. Prior art hoppers which have a sliding gate with a lip must be moved by an individual physically grasping the lip with his or her hand and pulling to open and pushing to close. The weight of feed in the hopper and the accumulation of feed particles on the gate makes movement of the gate extremely difficult, particularly where, as with prior art hoppers, an individual has to reach down in a position where he or she has little or no leverage to pull or push on the lip. As shown in FIG. 9 by exerting pressure on and causing movement of handle 11 an individual can easily open and close sliding gate or sliding valve 15 without undue exertion and without the possibility of injury, which was present using the prior art device.

One embodiment of the present invention is a hopper comprising a bin into which feed is introduced, the hopper having a fixed discharge opening positioned in a lower portion of the bin and a gate or valve positioned in a starting position beneath the discharge opening to prohibit discharge of feed therefrom when the gate or valve is in the starting position, wherein the gate or valve is adapted to be moved by a means for moving from its starting position beneath the discharge opening, in a first direction to open and in a second direction opposite the first direction to close, whereby moving the gate or valve from its starting position permits at least some of the feed to discharge from the hopper. Advantageously, the means for moving the gate further comprises a control assembly operably connected with the gate or valve and a handle operably connected to the control assembly, whereby movement of the handle causes movement of the gate or valve. Preferably, the control assembly comprises a rod and a pivot mechanism connection therebetween, the gate or valve operably connected to the rod such that movement of the handle causes the gate or valve to open and close and wherein the gate or valve is slideably mounted relative to the bin.

Another embodiment of the present invention is a method of discharging feed from a hopper, the hopper comprising a bin having a fixed discharge opening at a lower portion thereof, the method comprising providing an element in an obstructing position for obstructing the opening to thereby inhibit the discharge of feed from the opening and intermittently moving the element, from the obstructing position, in a first direction to a corresponding position in which the discharge opening is at least partially unobstructed to allow feed to flow through the discharge opening and thereafter moving the element in a second, opposite direction into a position beneath the opening so that feed flow is obstructed. Advantageously the step of intermittently moving further comprises moving the element in a first direction so that the discharge opening is at least partially unobstructed, whereby feed flows through said unobstructed area of the discharge opening and thereafter moving the element in a second, opposite direction into a position beneath the opening so that feed flow is obstructed.

A further embodiment of the present invention is a hopper for feed product comprising a bin having a product inlet at its upper end and a product discharge, comprised of a fixed outlet opening, at its lower end, a movable deflector, said deflector spaced below the fixed outlet opening in the lower end of the bin and slideably mounted in relation to the bin, wherein the deflector is positionable to obstruct the outlet opening, and a means for movement, coupled with the deflector, for sliding the deflector to thereby move the deflector at least partially away from the bin opening, thereby selectively discharging a quantity of product through the outlet opening.

Another embodiment of the present invention is an apparatus for controlling the distribution of feed from a hopper, the hopper having a discharge opening through a lower portion of the hopper, said apparatus comprising a frame supporting the hopper; a valve positioned proximate the discharge opening of the hopper; and positioning means for moving said valve between a closed position wherein said valve engages the discharge opening to impede feed flow and an open position wherein said valve is substantially separated from the discharge opening to allow feed to flow through the discharge opening. Advantageously said valve is a plate. Preferably said valve further includes a lip attached to said plate, said lip being connected to said positioning means. Advantageously said positioning means comprises a rod having a distal end and a proximal end, said proximal end of said rod connected to said valve; and a handle having a first end and a second end, said first end of said handle pivotally connected said distal end of said rod. Preferably said handle is pivotally connected to said frame and said handle is substantially L-shaped. Advantageously said first end of said handle is orthogonal to said second end of said handle.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

What is claimed is:

1. A hopper comprising:
a bin into which feed is introduced;
a fixed discharge opening positioned in a lower portion of said bin;
a gate positioned in a starting position beneath said discharge opening to prohibit discharge of feed therefrom when said gate is in the starting position, wherein said gate is adapted to be moved by a means for moving, from its starting position beneath the discharge opening, in a first direction to open and in a second direction opposite said first direction to close, whereby moving said gate from its starting position permits at least some of said feed to discharge from said hopper.

2. The hopper as set forth in claim 1 wherein said means for moving the gate further comprises:
a control assembly operably connected with said gate; and
a handle operably connected to said control assembly, whereby movement of said handle causes movement of said gate.

3. The hopper as set forth in claim 2 wherein said control assembly comprises a rod and a pivot mechanism connection therebetween, said gate operably connected to said rod such that movement of the handle causes the gate to open and close.

4. The hopper as set forth in claim 3 wherein said gate is slideably mounted relative to said bin.

5. A method of discharging feed from a hopper, said hopper comprising a bin having a fixed discharge opening at a lower portion thereof, said method comprising:
providing an element in an obstructing position for obstructing said opening to thereby inhibit the discharge of said feed from said opening; and
intermittently moving said element from said obstructing position in a first direction to a corresponding position in which said discharge opening is at least partially unobstructed to allow said feed to flow through said discharge opening.

6. The method as set forth in claim 5 wherein said step of intermittently moving further comprises:
moving said element in a first direction so that said discharge opening is at least partially unobstructed, whereby said feed flows through said unobstructed area of said discharge opening; and
thereafter moving said element in a second, opposite direction into a position beneath said opening so that said feed flow is obstructed.

7. A hopper for feed product comprising:
a bin having a product inlet at its upper end and a product discharge, comprised of a fixed outlet opening, at its lower end;
a movable deflector, said deflector spaced below the fixed outlet opening at the lower end of said bin and slideably mounted in relation to said bin, wherein said deflector is positionable to obstruct said outlet opening; and
a means for movement, coupled with said deflector, for sliding said deflector to thereby move said deflector at least partially away from the bin opening, thereby selectively discharging a quantity of product through said outlet opening.

8. An apparatus for controlling the distribution of feed from a hopper, the hopper having a discharge opening through a lower portion of the hopper, said apparatus comprising:
a frame supporting the hopper;
a valve positioned proximate the discharge opening of the hopper; and
positioning means for moving said valve between a closed position wherein said valve engages the discharge opening to impede feed flow and an open position wherein said valve is substantially separated from the discharge opening to allow feed to flow through the discharge opening.

9. The apparatus as described in claim 8, wherein said valve is a plate.

10. The apparatus as described in claim 9, said valve further including a lip attached to said plate, said lip being connected to said positioning means.

11. The apparatus as described in claim 8 wherein said positioning means comprises:
a rod having a distal end and a proximal end, said proximal end of said rod connected to said valve; and
a handle having a first end and a second end, said first end of said handle pivotally connected said distal end of said rod.

12. The apparatus as described in claim 11 wherein said handle is pivotally connected to said frame.

13. The apparatus as described in claim 11 wherein said handle is substantially L-shaped.

14. The apparatus as described in claim 11 wherein said first end of said handle is orthogonal to said second end of said handle.
